(19) United States
(12) Patent Application Publication
(10) Pub. No.: US 2006/0243465 A1
(43) Pub. Date: Nov. 2, 2006

(54) Material handling system

(76) Inventor: Bruce E. Kallevig, Monticello, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/395,112

(22) Filed: Mar. 31, 2006

Related U.S. Application Data
(60) Provisional application No. 60/667,805, filed on Apr. 1, 2005.

(51) Int. Cl. A01B 1/00

(52) U.S. Cl. 172/378

(57) ABSTRACT

A convertible tool system comprises a main tool and a second tool removably attachable to at least one tine of the first fork of the main tool. The main tool including a first support and a second support, the second support extending at an acute angle relative to the first support and the second support including a first fork of tines extending away from the first support. The second tool comprises at least one of a leveler and a second fork. The leveler includes a generally rectangular frame and at least one sleeve on the frame with the sleeve configured to removably mount the frame in position vertically spaced below the second support of the main tool. The second fork of tines is configured with the tines laterally spaced apart from each other and generally parallel to each other. The second fork includes at least one receiver configured to removably attach to the first fork of the main tool to interpose the tines of the second fork inbetween, respectively, the tines of the first fork of the main tool.

### CROSS-REFERENCE TO RELATED APPLICATION

This patent application claims the benefit of the filing date of Provisional U.S. patent application Ser. No. 60/667,805, entitled “MATERIAL HANDLING SYSTEM FOR SELF-PROPELLED VEHICLE,” having Attorney Docket Number K396.102.101 and having filing date of Apr. 1, 2005, which is incorporated herein by reference.

### BACKGROUND

Skid steer loaders have become common in construction and materials handling because of their relatively small size, which lends great versatility and maneuverability. However, in some instances, even these skid steer loaders are too large. Accordingly, a smaller vehicle has been developed, which is generally known as a self-propelled utility vehicle. These self-propelled vehicles are narrower, and more nimble, allowing the operator to negotiate tighter spaces. In these vehicles, instead of the operator sitting in the vehicle in a seat, the operator walks behind the vehicle and guides the vehicle with hand controls located at a rear of the vehicle. With the controls, the operator controls movement of the vehicle as well as operation of any attachments such as hydraulic tools, e.g. ditch digging equipment.

Many self-propelled vehicles are directed to supporting activities below the ground, such as ditch digging, and supplying hydraulic power to power tools and devices adapted for work below ground. Unfortunately, because of the limited types of uses by these vehicles, a work site conventionally also includes a skid-steer loader for carrying out tasks other than ditch digging and/or other than supplying hydraulic power to other tools. Having both a skid-steer loader and a self-propelled vehicle, such as a ditch-digging device, at a single work site is expensive, and can quickly create a crowded work site.

For these reasons, conventional skid-steer loaders and conventional self-propelled utility vehicles fail to efficiently and effectively meet the challenges presented at some common work environments in which they are used.

### SUMMARY

Embodiments of the invention are directed to a a convertible tool system for handling materials. In one embodiment, the convertible tool system comprises a main tool and a second tool. The main tool includes a first support and a second support, the second support extending at an angle relative to the first support and the second support including an first fork of tines extending away from the first support. The second tool is removably attachable to at least one tine of the first fork of the main tool and the second tool comprises at least one of a leveler and a second fork. The leveler includes a generally rectangular frame and at least one sleeve on the frame with the sleeve configured to removably mount the frame in position vertically spaced below the second support of the main tool. The second fork of tines is configured with the tines laterally spaced apart from each other and generally parallel to each other. The second fork includes at least one receiver configured to removably engage the first fork of the main tool to interpose the tines of the second fork between the tines of the first fork of the main tool.

### BRIEF DESCRIPTION OF THE DRAWINGS

FIG. 1 is a perspective view of a self-propelled vehicle including a material handling system, according to an embodiment of the present invention.

FIG. 2 is a perspective view of a self-propelled vehicle including a material handling system, according to an embodiment of the present invention.

FIG. 3 is a perspective view of a material handling system in an unassembled state, according to an embodiment of the present invention.

FIG. 4 is a perspective view of a base tool and a vertical support of a material handling system, according to an embodiment of the present invention.

FIG. 5 is a perspective view of a base tool and a vertical support of a material handling system, according to an embodiment of the present invention.

FIG. 6 is a side view of a base tool and a hook of a material handling system, according to an embodiment of the present invention.

FIG. 7 is a perspective view of a tine tool of a material handling system according to an embodiment of the invention.

FIG. 8 is a perspective view of a base tool, a vertical support, and a tine tool of a material handling system in an assembled state, according to an embodiment of the invention.

FIG. 9 is a perspective view of a base tool, a vertical support, and a tine tool of a material handling system in an assembled state, according to an embodiment of the invention,

FIG. 10A is a perspective view of a base tool, a vertical support, and a leveler tool of a material handling system in an assembled state, according to an embodiment of the present invention.

FIG. 10B is a side view of showing a portion of the base tool and a leveler tool, according to an embodiment of the invention.

### DETAILED DESCRIPTION

In the following detailed description, references made to the accompanying drawings, which form a part hereof, and which is illustrated by way of illustrations specific embodiments in which the invention may be practiced. In this regard, directional terminology, such as “front,” “back,” etc., is used with reference to the orientation of the figures(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments of the present invention are directed to material handling systems. In one embodiment, a material handling system is removably or permanently attachable to a loader arm mechanism of a self-propelled vehicle. In one embodiment, a material handling system comprises a primary tool including a horizontal support and a vertical support without any sidewalls joining the horizontal and vertical supports. The primary tool is open-sided, i.e., lacking side walls to enable the tool to carry object(s) with a length that exceeds a width of the primary tool, which is in stark contrast with a conventional loader bucket that is generally limited to carrying objects that fit laterally within the side walls of the bucket. The primary tool handles large rocks, timber, trees, hay etc. In one embodiment, the vertical support surface comprises a grid member enabling operator vision through the vertical support during operation of the material handling system. In one embodiment, the horizontal support is comprised of an array (or fork) of tines arranged generally parallel to, and spaced laterally apart from each other. The horizontal support is joined to the vertical support surface to form an angle of about 90 to 45 degrees (preferably 80 degrees) to facilitate handling materials.

In another embodiment, a second tool is removably mountable to the primary tool to add further strength and the capability to handle smaller objects. The second tool also comprises an array (or fork) of tines that are generally parallel to each other, and laterally spaced from each other. In one aspect, the second tool is slidably mounted onto the primary tool via a pair of sleeves that fit over tines of the primary tool wherein the tines of the second tool become interleaved or interposed between the tines of the primary tool.

In another embodiment, instead of mounting the second tool onto the primary tool, a leveler tool is removably mounted onto the primary tool. The leveler tool comprises a framework of interconnected lateral members arranged for pushing, filling, and leveling substances such as soil or aggregate materials. The lever tool is mounted onto the primary tool in a manner substantially similar to the mounting of the second tool onto the primary tool, except extending underneath and vertically spaced below the primary tool.

Accordingly, the second tool and leveler tool can be quickly interchanged with one another relative to primary tool via the slidable mounting mechanisms (described above) and the use of releasable fasteners (e.g. pins, bolts, etc.). In other embodiments, these material handling systems also can be removably attached to a loader arm mechanism of a skid-steer loader vehicle or other vehicles suited for material handling tasks (e.g. a utility tractor).

In one embodiment, a material handling system including its interchangeable set of tools (e.g., leveler tool, fine tine tool, see-through vertical support plate, base tine tool, etc.) is mountable onto a utility tractor at either a front end or a rear end of the tractor. In one aspect, the base tool is removably mounted onto a free end of a hydraulically-powered, loader arm mechanism (maneuverable in a variable vertical position and capable of rotational manipulation of the free end of the loader arm) at the front end of the utility tractor in place of a conventional loader bucket. In another aspect, the base tool is removably mounted onto a conventional three-point hitch mechanism (maneuverable within a small range of motion via hydraulic control) at the rear end of the utility tractor in place of conventional three-point hitch tools (e.g. drag sections, disc, etc). With the base tool mounted on the utility tractor at the front end or the rear end, the other tools of the material handling system are mountable onto the base tool in an interchangeable manner to adapt the material handling system to a particular use. In another embodiment, two material handling systems are mounted onto a vehicle, such as a utility tractor, with one material handling system mounted at a front end and another material handling system mounted at a rear end of the tractor. Moreover, in another embodiment, the utility tractor comprises a loader arm mechanism extending from a rear end of the tractor, and on which a material handling system of the present invention is removably mountable.

In addition, in another embodiment a material handling system (e.g., leveler tool, fine tine tool, see-through vertical support plate, base tine tool, etc.) is removably mountable onto a stationary material handing system (e.g., a workstation) having a loader arm mechanism (e.g., hydraulically powered) capable of maneuvering the material handling system in a multidirectional orientation (e.g., up, down, left, right, in, out). In one aspect, the loader arm mechanism is a crane arm mechanism. In this embodiment, the material handling system retains its transformational nature with interchangeable tools except it is deployed at a non-mobile workstation structure at a loading dock, materials yard, etc. for handling materials and objects.

Accordingly, embodiments of the invention enable highly flexible use of self-propelled vehicles, utility tractors, skid-steer loaders, etc. to become versatile material handlers that are adaptable to a wide variety of conditions with a single, integrated system of interchangeable tools. This material handling system is readily employed by simple, removable mounting on existing loader arm mechanisms and/or hitch mechanisms of these vehicles.

With each interchange of the tools relative to the base tool of the material handling system, the material handling system transforms itself from one type of tool into a second different tool, without disconnection of the entire material handling system from the vehicle (or station on which the material handling system is mounted) as would occur with conventional attachments.

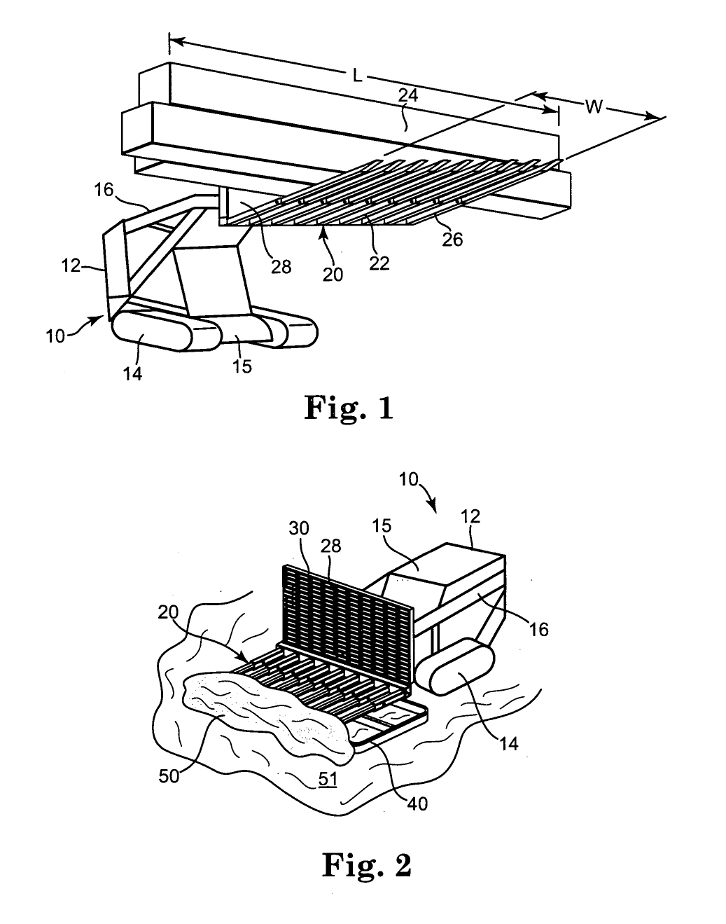

These embodiments of the invention, and additional embodiments are described and illustrated in detail in association with FIGS. 1-10B.

FIG. 1 is a perspective view of a self-propelled vehicle 10, according to one embodiment of the invention. As shown in FIG. 1, vehicle 10 includes vehicle frame 12, mover 14, front portion 15, loader arm mechanism 16, and material handling system 20 including a tool 22 for carrying objects 24. Tool 22 is removably attachable to an end of loader arm mechanism 16. Mover 14 comprises a drive mechanism such as power-driven wheels, tracks, etc. Tool 22 of material handling system 20 is sized, shaped, and positioned to uphold objects 24 on tool 22 in a stable position while vehicle 10 is stationary or mobile. Loader arm mechanism 16 is pivotally mounted relative to vehicle frame 12 and supports tool 22 in an elevated position, in a lowered position (shown in FIG. 2), and/or various positions in between the elevated and lowered positions, as well as controlling a rotational position of tool 22.

Tool 22 includes a horizontal support 26 for supporting objects, and a vertical member 28 for supporting objects. Tool 22 is generally L shaped when viewed in cross section. In one embodiments, tool 22 is configured with open sides (e.g., omitting supports extending between vertical member 28 and horizontal support 26), so that the tool 22 is capable of supporting objects that have a length that substantially exceed a width of the tool 22. As shown in FIG. 1, objects 24, such as railroad ties, beams, poles, etc, have a length (L) far exceeding a width (W) of tool 22.

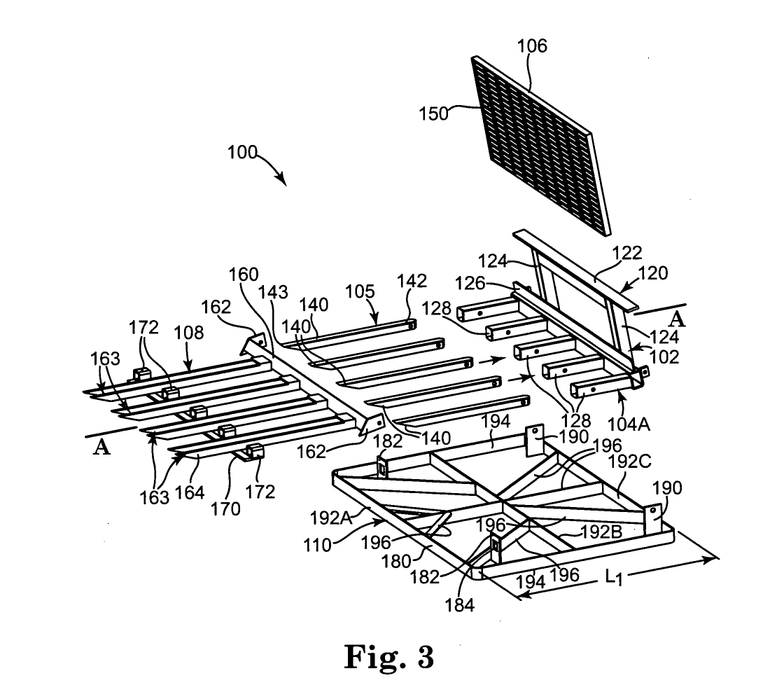

In one embodiment, horizontal support 26 of tool 22 comprises a fork including a plurality of generally parallel, laterally spaced apart tines. This arrangement provides strength, with less weight, and enables performing other tasks. A more detailed illustration and description of aspects of tool 22 is in association with FIGS. 3-10B.

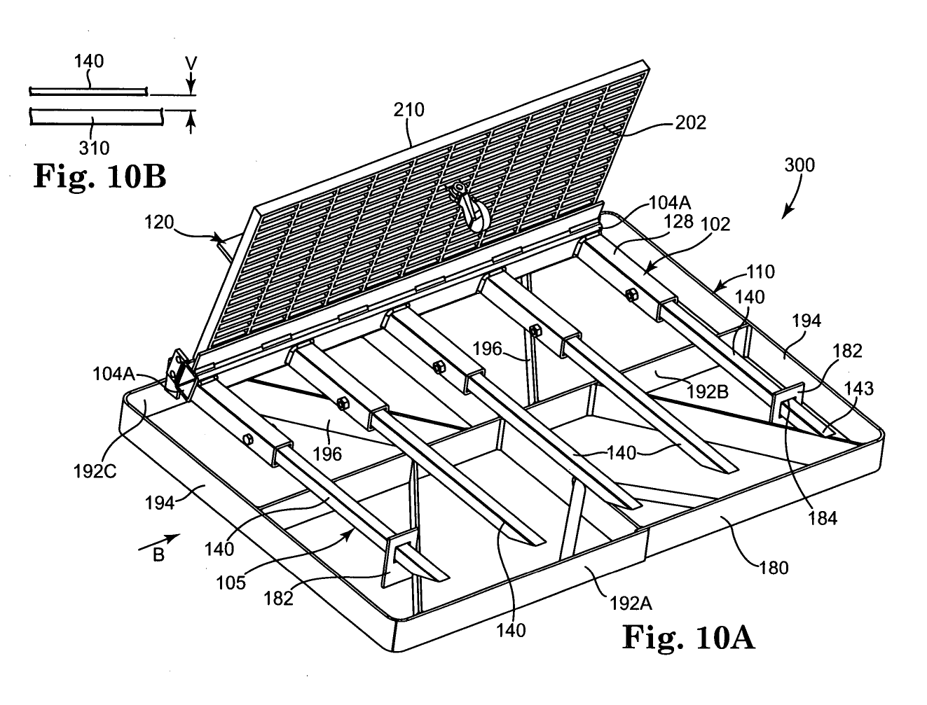

FIG. 2 is a perspective view of a self-propelled vehicle 12 including a material handling system 20. As shown in FIG. 2, loader arm mechanism 16 is in a lowered position, thereby placing material handling system 20 adjacent ground 51. In this embodiment, material handling system 20 includes vertical support 30 (as a vertical member 28) and leveler tool 40 as part of tool 22. Upon locomotion of vehicle 10, and with leveler 40 in contact with ground 51, tool 22 acts to level ground 51 including mound 50 of soil. As shown in FIG. 2, tool 22 still retains a configuration suited to carrying objects, but is used in a different mode via attachment of leveler tool 40 at a bottom portion of tool 22. A more detailed illustration and description of leveler tool 40 will be made later in association with FIGS. 3, 10A and 10B.

Material handling system 20 is described and illustrated in greater detail in association with FIGS. 3-10.

FIG. 3 is a perspective view of a material handling system 100, according to an embodiment of the invention. Material handling system 100 has substantially the same features and attributes as material handling system 20 described in association with FIGS. 1-2.

As shown in FIG. 3, material handling system 100 comprises base tool 102 including base portion 104A comprising fork 105 (i.e., a primary tool), vertical support 106, tine tool 108 (i.e. a second tool), and leveler tool 110.

In one embodiment, base portion 104A of base tool 102 includes mount frame 120 comprising upright members 124 and lateral member 122 extending therebetween. In one aspect, mount frame 120 is configured to mount base tool 102 onto an end of a loader arm of a vehicle (or a stationary workstation) or a hitch of a vehicle. Base portion 104A also comprises a plurality of sleeves 128 (e.g., a receiver) that are generally parallel and laterally spaced from each other, and secured adjacent lateral anchor 126. Each sleeve 128 is sized, shaped and positioned to slidably receive one tine 140 of fork 105, with a first end of each tine 140 being slidably inserted into each sleeve 128, to orient tines 140 extending outward from base portion 104A. Accordingly, in this arrangement, tines 140 of fork 105 arrange the removably secured tines 140 in a generally parallel array in which the respective tines 140 are laterally spaced apart from each other. While FIG. 3 shows five tines 140, there can more than five or less than five tines, with a corresponding greater or lesser number of sleeves 128 to receive those tines.

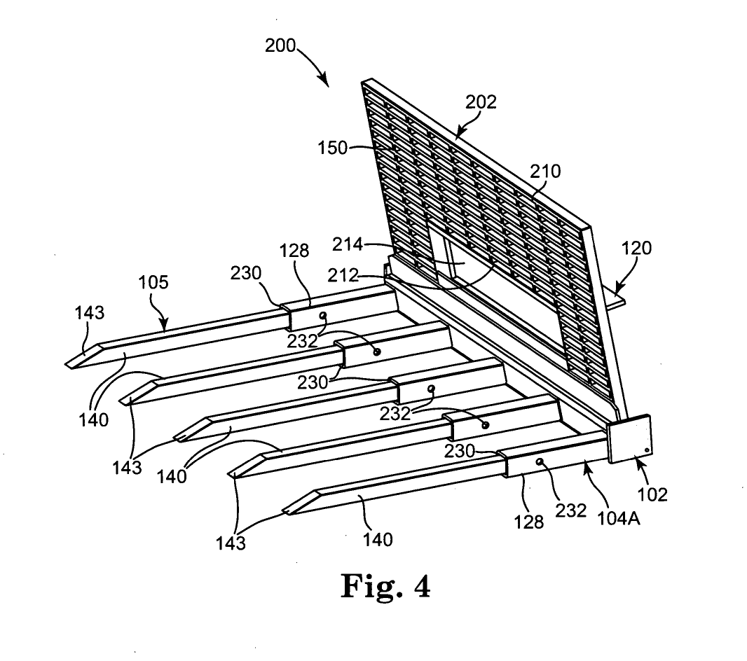

Vertical support 106 has substantially the same features and attributes as vertical support 30, as described and illustrated in association with FIGS. 1-2. In one aspect, vertical support 106 comprises a generally rectangular shaped frame including a grid 150 or latticework of spaced apart members that provides rigidity and strength, while enabling an operator to see through the grid. Vertical support 106 is sized, shaped, and adapted to be secured relative to support 120 of base portion 104A of base tool 102. In one embodiment, vertical support 106 is generally uniform latticework, while in other embodiments, vertical support 106 has one or more portions omitting support members of grid 150, such as later shown in FIGS. 4-5, 8 and 9 to define openings to increase the visibility through vertical support 106.

In one embodiment, vertical support 106 is a generally rectangular member. In another embodiment, vertical support 106 is made from a non-metal material or composite material, such as a plastic material, to provide a strong, rigid frame having light weight. In other embodiments, vertical support 106 is made from a metal material.

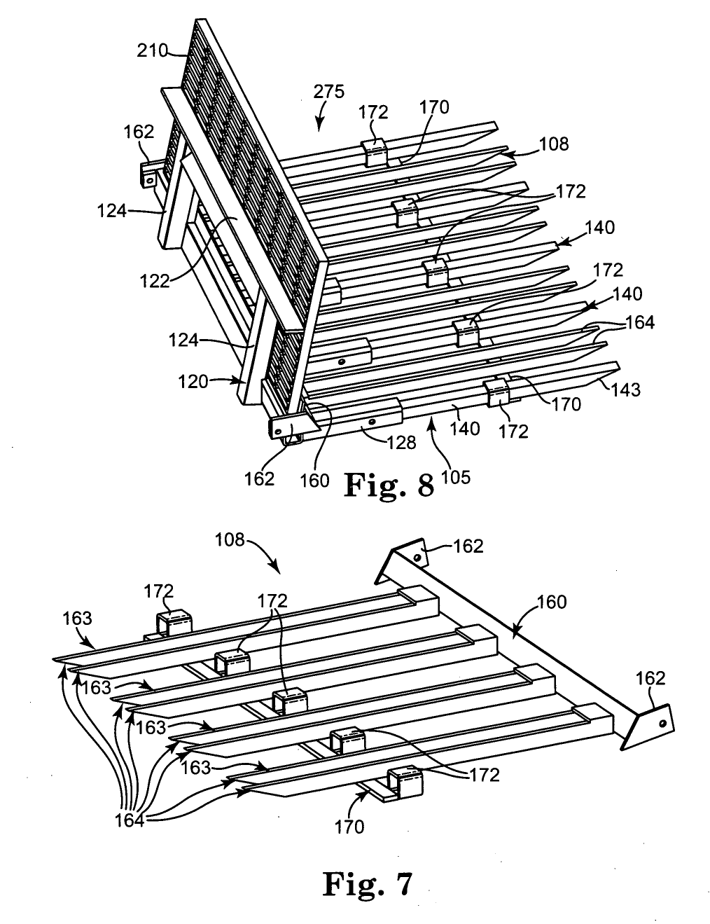

As shown in FIG. 3, second tine tool 108 is sized and shaped for removable engagement onto base tool 102, which is illustrated more fully in association with FIGS. 7-9. As shown in FIG. 3, second tine tool 108 comprises lateral base 160 (with wings 162), pairs 163 of tines 164, and transverse member 170 with sleeves 172. Tines 164 are grouped in pairs and extend outwardly from lateral base 160 in a generally parallel, spaced relationship. Transverse member 170 extends transversely across tines 164 to interconnect tines 164 to each other, and includes sleeves 172 (e.g., receivers) which are sized and positioned along transverse member 170 between adjacent pairs of fine tines 164. In one aspect, transverse member 170 extends generally perpendicular to tines 164, as shown in FIGS. 7-9. In another aspect, sleeves 172 are sized and positioned to slidably receive tines 140 of base tool 102 when second tine tool 108 is slidably attached to base tool 102, thereby interposing or interleaving tines 140 of fork 105 (base tool 102) with tines 164 of second tine tool 108 (i.e., a second fork). Second tine tool 108 is shown in its assembled state with base tool 102 in association with FIGS. 7-9.

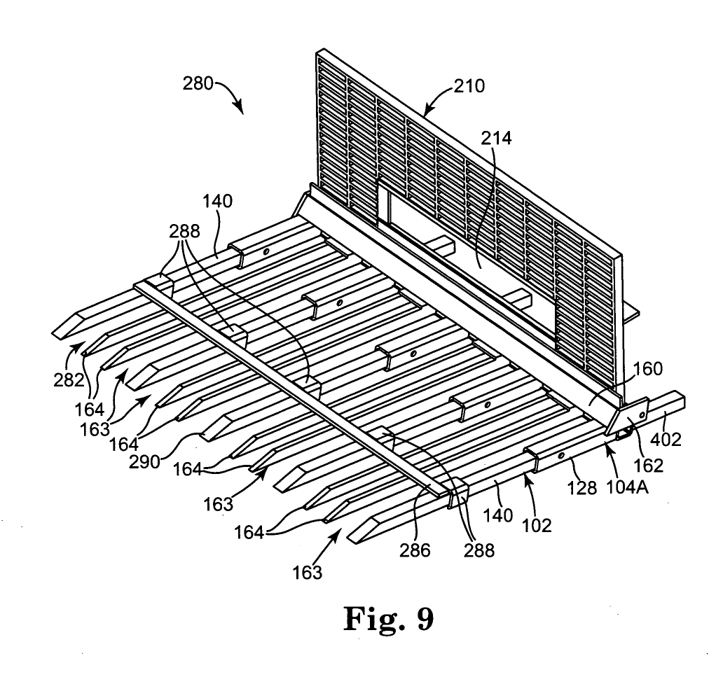

In one aspect, a length of tines 164 of second tool 108 (or a length of leveler tool 110) is substantially equal to a length of tines 140 of base tool 102 (when mounted in sleeves 128), as illustrated in FIGS. 8-9. In another aspect, tines 164 of second tine tool 108 (or leveler tool 110) have a length different than (more or less) than the length of tines 140 of base tool 102.

As further shown in FIG. 3, leveler tool 110 is sized and shaped for removable attachment to base tool 102. Leveler tool 110 has substantially the same features and benefits as leveler 40, previously described and illustrated in association with FIG. 2. Leveler tool 110 is shown in an assembled/attached state in detail in association with FIGS. 10A-10B.

As shown in FIG. 3, in one aspect, leveler tool 110 comprises a generally rectangular frame 180, front hanger members 182 with holes 184, and rear hanger members 190 laterally spaced at opposite sides of frame 180. In one aspect, hanger members 182 or 190 are replaced with receivers or sleeves similar to sleeves 128 of base tool 102 shown in FIG. 3).

In one aspect, frame 180 also comprises first lateral member 192A, second lateral member 192B, and third lateral member 192C, which are arranged generally parallel to each other and laterally spaced apart from each other while each member 192A-192C has a generally vertical orientation. In another aspect, various intermediate members 196 extend between lateral members 192A-192C in different orientations to provide strength and rigidity to frame 180. Lateral members 192A-192C are sized, shaped, and spaced from each other, and to be generally perpendicular to a longitudinal axis (as generally represented by line A in FIG. 3)of tines 140 of base tool 102 to enable leveling of soil or other substances. In one embodiment, lateral member 192A functions as a bulldozer pushing a bulk of soil in which frame 180 is interacting, while lateral members 192B and 192C act to fill and/or level soil. Of course, when leveler tool 110 is used in a reverse locomotion, the role of lateral members 192A-192C is reversed. Finally, those skilled in the art will recognize various functions of members of frame 180 as leveler tool 110 and/or vehicle 10 are maneuvered in various orientations and movements familiar to those operating soil leveling equipment.

Hangers 182 are sized, shaped and positioned to act as receivers for slidable reception over tines 140 of base tool 102 to achieve an assembled state, with leveler tool 110 being vertically spaced below base tool 102, as shown in FIGS. 10A-10B. Additional aspects of leveler tool 110 are further illustrated and/or described later in association with FIGS. 10A-10B.

Second tine tool 108, and leveler tool 110 are removably attachable relative to base tool 102, as will be further described and illustrated in association FIGS. 4-10B.

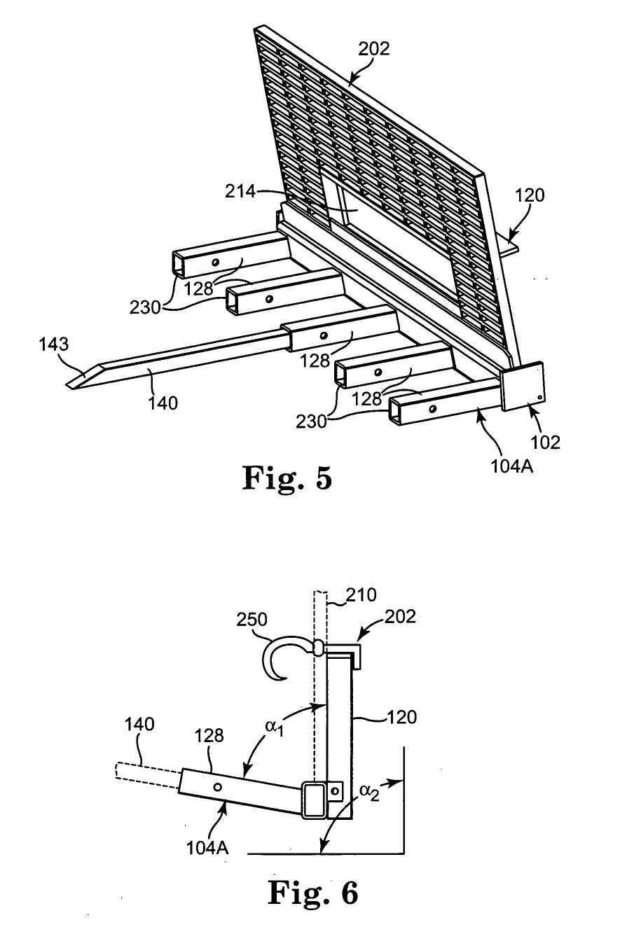

FIG. 4 is a perspective view of a material handling system 200 including a primary tool 202 arranged to include a base tool 102 and vertical support 210. Vertical support 210 has substantially the same features and attributes as vertical support 30, 106. Base tool 102 has substantially the same features and attributes as base tool 102 shown in FIG. 3, with tines 140 removably secured within sleeves 128 of base portion 104A. Each sleeve 128 includes an opening 230 (see FIG. 5) out of which each tine 140 extends, and is associated with a fastening mechanism 232 for securing each tine 140 within each sleeve 128. The fastening mechanism 232 is a bolt, pin, or other fastener. In one aspect, tines 140 are generally parallel to each other and spaced laterally from each other.

Using vehicle 10, primary tool 202 is maneuvered to scoop up objects to be carried by primary tool or is set down so that objects can be loaded onto primary tool 202. In one aspect, fork 105 (including tines 140 and base portion 140A) creates a bed on which the objects can be loaded. Fork 105 is sized and shaped to handle objects such as rocks, boulders, timbers, paving stones, nursery supplies (e.g. trees, bushes, etc).

In one aspect, fork 105 on base tool 102 is generally flat enabling stable support of objects that could not otherwise be stably positioned within a conventional loader bucket. In addition, the spacing between the tines 140, along with the beveled ends 143 of tines 140 also facilitate picking up irregularly shaped objects such as one or more larger rocks/boulders (especially from a pile of rock/boulders) because the tines 140 can penetrate into spaces between the rocks/boulders, whereas a front edge of a conventional loader bucket may have difficulty penetrating a pile of rocks/boulders to enable lifting some rocks/boulders out the pile.

In addition, to further balance a load on fork 105, vertical support 210 prevents horizontal or lateral movement of an object, e.g. boulder, timbers, off of fork 105 toward front portion 15 of vehicle (FIGS. 1-2). In other words, objects handled via base tool 102 with vertical support 210 are cradled between fork 105 and vertical support 210. In one embodiment, as shown in FIG. 6, sleeves 128 of base portion 104A are arranged at a generally acute angle between 45 to 90 degrees (e.g. 80 degrees) relative to vertical support 210 to further enhance cradling of objects into a stable position between the fork 105 and vertical support 210. In addition, an operator of vehicle 10 can manipulate loader arm mechanism 16 to rotate primary tool 202 upward and toward vehicle 10, or downward and away from vehicle 10 to further stabilize or dump, respectively, objects carried by primary tool 202.

Accordingly, other objects such as smaller bails of hay can be scooped up via primary tool 202. In one embodiment, primary tool 202 also is used as a fork-lift type device wherein several tines 140 of primary tool 202 are maneuvered via vehicle 10 (and its loader arm mechanism 16) for insertion into slots of a pallet to enable picking up a pallet via primary tool 202.

In another embodiment, primary tool 202 is arranged so that tines 140 are spaced laterally to enable engaging a conventional pallet, although the lateral spacing between tines 140 is altered in other embodiments to accommodate interaction with other sized/shaped pallets or other similar structures related to handling materials.

Vertical support 210 also enables an operator of a self-propelled vehicle 10 to enjoy significant vision through the open spaces within grid 150 of vertical support 210 to see the objects being loaded/scooped, and in particular, to see how one or more tines 140 of base tool 102 are interacting with the objects. This vision greatly aids single operator use of a material handling system 200 since a second person need not act as a guide to direct the operator of vehicle 10 to maneuver the tool picking up the object (as might be required with conventional opaque buckets that obscure an operator's vision).

In another embodiment, vertical support member 210 is a generally opaque member formed from a solid member, as might be desired to limit migration of a material or object through a grid 150 of vertical support member 210.

FIG. 5 is a perspective view of a primary tool 202, according to an embodiment of the invention. As shown in FIG. 5, primary tool 202 has substantially the same features and attributes as primary tool 202 shown in FIG. 4, except that only a central tine 140 extends from base portion 104A, with the remaining tines 140 having been removed (or not initially installed in sleeves 128). In this embodiment, primary tool 202 is especially adapted for spearing objects, such as bails of hay, for lifting and maneuvering via primary tool (as supported by loader arm mechanism 16 and vehicle 10).

In other embodiments, tines 140 are installed in different combinations to achieve a desired effect of manipulating objects with one or more tines. In one example, only the two outermost tines 140 of fork 105 (FIG. 4) are installed into the outermost sleeves 128 of base portion 104A. In another example, tines 140 are installed in an alternating fashion, in every other sleeve 128 laterally across base portion 104A. Other combinations and arrangements of tines 140 on base portion 104A that are useful for handling materials via primary tool 202 will be apparent to those skilled in the art.

FIG. 6 is a side view of primary tool 202, illustrating an angle (α₁) formed between sleeves 128 of base portion 104A (and tines 140) relative to vertical support 210 (as positioned via support 120) and an angle (α₂) corresponding generally with an angle of rotation of primary tool 202 relative to vehicle 10 via manipulation of loader arm mechanism 16. Accordingly, angle (α₁) is fixed at the time of manufacture of primary tool 202 while angle (α₂) is variable at the discretion of the operator of vehicle 10. As shown in FIG. 6, angle (α₁) is about 80 degrees although in other embodiments, angle (α₁) is set within a range of 90 degrees (generally perpendicular) to 45 degrees, as desired to suit an operating environment.

FIG. 6 further illustrates a hook 250 that is removably securable relative to primary tool 202 at or near vertical support 210. In one embodiment, hook 250 is secured to primary tool 202 via a fastener in a manner in which hook 250 extends through vertical support 210 and/or through base vertical support 120. Hook 250 enables use of a cable or other means to be secured on an object(s) and then secured to hook 250, thereby enabling vehicle 10 (via loader arm mechanism) to raise that object off the ground (or other work surface) or to drag that object when primary tool 202 is elevated vertically and/or when vehicle 10 is moved relative to the object. In another embodiment, hook 250 acts as a tie-down anchor to receive straps, cables, etc. to tie down an object onto primary tool 202 and can be oriented facing upward or downward.

Of course, tines 140 of fork 105 can also be used as tie-down anchors by themselves, in cooperation with hook 250, and/or in cooperation with portions of vertical support 210.

FIG. 7 is an enlarged perspective view of second tine tool 108, according to an embodiment of the invention. Second tine tool 108 has substantially the same features and attributes as described and illustrated in association with FIG. 3, and as described throughout this specification.

FIG. 8 is a perspective view of a material handling system arranged as a second tool 275, according to an embodiment of the invention. As shown in FIG. 8, second tine tool 108 is removably secured relative to base tool 102 with vertical support 210 secured as previously described. Upon installation of second tine tool 108, pairs 163 of tines 164 are interleaved (or interposed) between tines 140 of fork 105 of base tool 102 to produce a load support surface with a significantly greater number of tines as compared to fork 105 alone of primary tool 202 shown and described in association with FIG. 4.

This second tool 275 is adapted for handling loads in a manner substantially the same as primary tool 202, except that the greater number of tines 140 and 164 enable handling of materials of a smaller size and/or composition. For example, second tool 275 is especially adapted for handling manure, collections of smaller rocks (those small enough that they would fall between tines 140 of primary tool 202), paver stones, hay, brush, etc.

Second tine tool 108 is installed by slidably inserting tines 140 of base tool 102 into and through sleeves 172 of second tine tool 108. Since transverse member 170 that supports sleeves 172 is connected to each tine 164 of second tine tool 108, this arrangement results in transverse member 170 becoming in contact with, and laterally extending across tines 140 of fork 105 of base tool 102. In addition, in one aspect, anchor member 160 is forced into contact against base portion 104A generally and/or against a lower portion of support 120 of base portion 104A. Wings 162 of anchor member are releasably fastened to base portion 104A to secure second tine tool 108 in place relative to base tool 102.

FIG. 9 is a perspective view of another tine tool 282 as part of a material handling system 280, according to an embodiment of the invention. As shown in FIG. 9, tine tool 282 replaces second tine tool 108 on base tool 102. Tine tool 282 has substantially the same features and attributes as second tine tool 108 (FIGS. 3, 6-7) except that tine tool 282 includes a modified mechanism for installation (relative to tines 140 of base tool 102). In particular, as shown in FIG. 9, tine tool 282 comprises pairs 163 of tines 164 (as in second tine tool 108) and lateral member 286 (with sleeves 288) that laterally extends across and is connected to each tine 164.

In one embodiment, as shown in FIG. 9, lateral member 286 includes sleeves 288 and tine tool 282 is installed by positioning the sleeve 288 relative to, and slidably moved onto tines 140 (including central tine 290) of base tool 102 and then slid toward base portion 104A. Lateral member 286 extends from sleeve 288 laterally across tines 140 of base tool 102 and above tines 140 to support tine tool 282 of base tool 102.

In another embodiment, lateral member 286 includes only a single sleeve 288 and tine tool 282 is installed by positioning the single sleeve 288 relative to, and slidably moved onto a central tine 290 of base tool 102 and then slid toward base portion 104A.

FIG. 10A is a perspective view of a material handling system 300, according to an embodiment of the invention. As shown in FIG. 10A, material handling system 300 comprises base tool 102 (having substantially the same features and attributes as in previous embodiments) and leveler tool 110. As shown in FIG. 10A, leveler tool 110 comprises lateral members 192A-192C, side members 194, and interior supports 196 connected in a framework.

In another aspect, leveler tool 110 also comprises hanger members 182 that act as receivers for slidably mounting onto one or more tines 140 of base tool 102. Accordingly, hanger members 182 support leveler tool 110 in a vertically spaced position beneath base tool 102.

FIG. 10B is a side view of material handling system 300, illustrating a vertical spacing (V) between a tine 140 and a member of leveler tool 110 (such as side members 194, lateral members 192A-192C) upon installation of leveler tool 110 onto base tool 102. Vertical spacing (V) enables movement of soil (or other substances) between base tool 102 and leveler tool 110 to facilitate leveling and filling functions carried out by leveler tool 110. Vertical spacing (V) can range from zero inches to six (or more) inches as determined at the time of manufacture of leveler tool 110 and as implemented via the size, shape and positioning of hanger members 182.

Embodiments of the present invention are directed to a material handling system(s) that adapt to conditions of use via removably mountable tools, with each tool adapted to a particular function such as leveling soil, lifting timber, etc. These material handling systems transform self-propelled vehicles from their conventional focus on below ground task to a highly adaptable use for above ground tasks, greatly increasing the utility of these types of vehicles.

Although specific embodiments have been illustrated and described herein for purposes of description of the preferred embodiment, it will be appreciated by those of ordinary skill in the art that a wide variety of alternate and/or equivalent implementations may be substituted for the specific embodiments illustrated and described without departing from the scope of the present invention. Those with skill in the mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A material handling system comprising:
a convertible tool attachable to a mount of a material handling station, the convertible tool including a generally horizontal support member and a generally vertical support member, the horizontal support member being independent and separate from the vertical support member and extending at a generally perpendicular angle relative to the vertical support member wherein at least one supplemental tool is removably attachable to the generally horizontal support member.

2. The material handling system of claim 1 wherein the material handling station comprises a self-propelled vehicle.

3. The material handling system of claim 2 wherein the self-propelled vehicle comprises:
a frame and a mover configured to cause locomotion of the frame; and
a loader arm mechanism pivotally mounted to the frame and configured to support the mount.

4. The vehicle of claim 1 wherein the vertical support comprises:
a mounting frame configured for attachment to the mount of the material handling station; and
a generally rectangular grid member removably secured to the mounting frame, wherein the grid member extends generally vertically relative to the generally horizontal support and comprises a latticework of support members, the support members spaced apart from each other to permit visibility through the grid member.

5. The vehicle of claim 4 wherein the grid member comprises a non-metal composite material.

6. The vehicle of claim 4 wherein the grid member comprises a generally rectangular opening defined adjacent a midportion of the grid member to enable line-of-sight vision of the horizontal support through the opening.

7. The vehicle of claim 1 wherein the horizontal support member comprises a primary tool including:
a base extending outward from the mounting frame of the vertical support and including a plurality of receivers arranged generally parallel to each other; and
a first array of tines with at least one tine of the first array removably secured relative to one of the respective receivers of the base to orient the at least one tine to extend outwardly from the base at a generally acute angle relative to the vertical support.

8. The vehicle of claim 7 wherein each respective tine of the first array of tines is removably secured relative to each respective receiver of the base to arrange the removably secured tines in a generally parallel array in which the respective tines are laterally spaced apart from each other.

9. The vehicle of claim 8 and further comprising a second tool removably securable relative to the primary tool, the second tool including:
a second array of interconnected tines extending generally parallel to and laterally spaced apart from each other, the tines of the second array being configured to be interposed between the respective tines of the first array upon slidably securing the second tool onto the primary tool.

10. The vehicle of claim 9 wherein the tines of the second array are interconnected via a tranverse support member that extends generally transverse to a longitudinal axis of the tines of the second array, the second array of tines is slidably mountable onto the first array of tines via at least one receiver sleeve of the transverse support member.

11. The material handling system of claim 9 wherein the tines of the second array have a length substantially equal to a length of the tines of the first array.

12. The vehicle of claim 7 and further comprising a leveler tool removably securable relative to the primary tool, the leveler tool comprising:
at least one receiver configured for slidably engaging the respective tines of the primary tool for removably securing the leveler tool relative to the primary tool in a position vertically spaced below the primary tool.

13. The vehicle of claim 11 wherein the leveler tool comprises
a framework of generally vertically oriented support members wherein the support members are laterally spaced apart from each other in a generally parallel relationship, the respective support members extending generally transverse to a longitudinal axis of the respective tines of first array of the primary tool.

14. A convertible tool system comprising:
a main tool including a first support and a second support, the second support extending at a generally acute angle relative to the first support and the second support including an first fork of tines extending away from the first support to be generally parallel to each other and laterally spaced apart from each other; and
a second tool removably attachable to at least one tine of the first fork of the main tool, the second tool comprising at least one of:
a leveler including a generally rectangular frame and at least one sleeve on the frame, the sleeve configured to removably mount the frame in position vertically spaced below the second support of the main tool.
a second fork of tines, the tines laterally spaced apart from each other and generally parallel to each other, wherein the second fork includes at least one receiver configured to removably attach to the first fork of the main tool to interpose the tines of the second fork inbetween, respectively, the tines of the first fork of the main tool.

15. The convertible tool system of claim 14 wherein the second support is removably attachable relative to the first support, and the generally acute angle is between about 45 to 90 degrees.

16. The convertible tool system of claim 14 wherein at least one of the tines of the first fork of tines of the main tool is removable from a base of the first fork of tines to configure the first fork of tines with at least one tine.

17. The convertible tool system of claim 14 and further comprising:
a self-propelled vehicle including an arm mechanism configured for removably mounting the main tool to an end of the arm mechanism, and the arm mechanism configured for rotatably positioning the main tool and configured to vertically position the main tool relative to the a frame of the self-propelled vehicle.

18. A method of handling materials, the method comprising:
supporting a convertible tool on a loader arm of a self-propelled vehicle, the convertible tool comprising a generally vertically upright grid and a generally horizontal fork extending outward from the grid; and
interchangeably mounting at least one a leveler tool and a tine tool onto the fork wherein the leveler tool is configured to be vertically spaced below the fork when slidably mounted onto the fork and wherein the tine tool is configured with an array of tines arranged to interleave between tines of the fork when slidably mounted on the fork.

19. The method of claim 18 wherein supporting the convertible tool comprises arranging the fork to include only a single tine and omitting the mounting of both the leveler tool and the tine tool.

20. The method of claim 18 wherein a frame of the leveler tool and the tines of the tine tool have a length generally equal to a length of the tines of the fork of the convertible tool.
